(19) United States
(12) Patent Application Publication
(10) Pub. No.: US 2011/0154193 A1
(43) Pub. Date: Jun. 23, 2011

(54) Method and Apparatus for Text Input

(75) Inventors: Mathias Johan Philip Creutz, Helsinki (FI); Jani Kristian Nurminen, Lempaala (FI)

(73) Assignee: NOKIA CORPORATION, Espoo (FI)

(21) Appl. No.: 12/643,301

(22) Filed: Dec. 21, 2009

(51) Int. Cl. G06F 17/24

(52) U.S. Cl. 715/261

(57) ABSTRACT

In accordance with an example embodiment of the present invention, there is provided a method comprising receiving a first text input at a first point in time, providing a first completion candidate for the first text input, receiving a second text input at a second point in time, determining a time difference between the second point in time and the first point in time and providing a second completion candidate for the second text input based on at least the first completion candidate and the time difference.

### TECHNICAL FIELD

The present application relates generally to user input. The present application relates in an example to text input and in particular, but not exclusively, to providing word completion candidates.

### BACKGROUND

Currently there are several different kinds of apparatuses with several different kinds of input methods. One widely studied area of input methods is text input for which predictive systems have been developed to make text entry quicker and easier.

### SUMMARY

Various aspects of examples of the invention are set out in the claims.

According to a first aspect of the present invention there is provided a method comprising: receiving a first text input at a first point in time, providing a first completion candidate for the first text input, receiving a second text input at a second point in time, determining a time difference between the second point in time and the first point in time, and providing a second completion candidate for the second text input based on at least the first completion candidate and the time difference.

According to a second aspect of the present invention there is provided an apparatus, comprising a processor and memory including computer program code, the memory and the computer program code configured to, working with the processor, cause the apparatus to perform at least the following: receive a first text input at a first point in time, provide a first completion candidate for the first text input in response to receiving the first text input, receive a second text input at a second point in time, determine a time difference between the second point in time and the first point in time in response to receiving the second text input and provide a second completion candidate for the second text input based on the first input candidate and the time difference.

According to a third aspect of the present invention there is provided a computer program product comprising a computer-readable medium bearing computer program code embodied therein for use with a computer, the computer program code comprising: code for receiving a first text input at a first point in time, code for providing a first completion candidate for the first text input, code for receiving a second text input at a second point in time, code for determining a time difference between the second point in time and the first point in time, and code for providing a second completion candidate for the second text input based on the first input candidate and the time difference.

According to a fourth aspect of the present invention, there is provided an apparatus comprising: means for receiving a first text input at a first point in time, means for providing a first completion candidate for the first text input, means for receiving a second text input at a second point in time, means for determining a time difference between the second point in time and the first point in time, and means for providing a second completion candidate for the second text input based on the first input candidate and the time difference.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of an example apparatus in which aspects of the disclosed embodiments may be applied;

FIG. 2 illustrates an exemplary user interface incorporating aspects of the disclosed embodiments;

FIGS. 3A to 3C illustrate an exemplary method incorporating aspects of the disclosed embodiments;

FIGS. 4A to 4D illustrate another exemplary method incorporating aspects of the disclosed embodiments;

FIG. 5 illustrates an exemplary process incorporating aspects of the disclosed embodiments;

FIG. 6 illustrates another exemplary process incorporating aspects of the disclosed embodiments; and

FIG. 7 illustrates yet another exemplary process incorporating aspects of the disclosed embodiments.

### DETAILED DESCRIPTION OF THE DRAWINGS

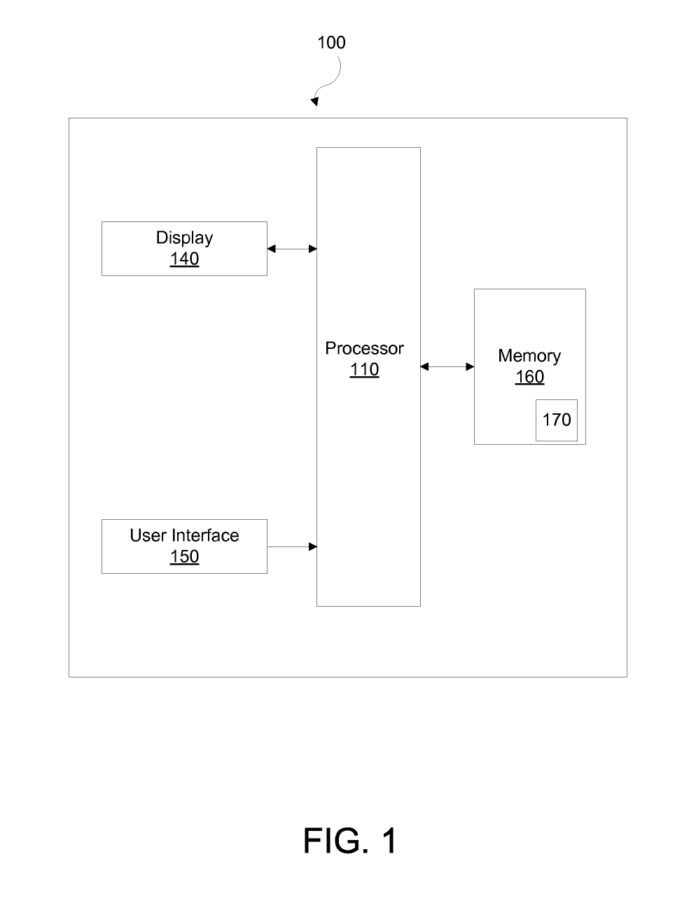

An example embodiment of the present invention and its potential advantages are understood by referring to FIGS. 1 through 7 of the drawings.

The aspects of the disclosed embodiments generally provide techniques for user input. In particular, some examples relate to text input in an apparatus.

Some exemplary embodiments relate to using a predictive text entry functionality when inputting text. In general, a predictive text entry functionality is a system for determining, estimating, calculating or guessing the text or a continuation of a text that a user intends to input. Some examples relate to an autocompletion system for providing a completion candidate for text input.

Some more specific examples relate to providing an autocompletion system for providing and rotating completion candidates for character input in an electronic device. In response to receiving the text input, the electronic device provides a completion candidate for the text input. The autocompletion system is configured to avoid presenting the same completion candidates multiple times by rotating the completion candidates if the user's actions suggest that the user is not interested in an offered completion candidate. In other words, a specified user action may be used as a trigger for rotating completion candidates.

FIG. 1 is a block diagram depicting an apparatus 100 operating in accordance with an example embodiment of the invention. Generally, the electronic device 100 includes a processor 110, a memory 160 and a user interface 150.

In the example the processor is a control unit that is connected to read and write from the memory 160 and configured to receive control signals received via the user interface 150. The processor may also be configured to convert the received control signals into appropriate commands for controlling functionalities of the apparatus. In another exemplary embodiment the apparatus may comprise more than one processor.

The memory 160 stores a prediction system 170 and computer program instructions which when loaded into the processor 110 control the operation of the apparatus as explained below. In another exemplary embodiment the apparatus may comprise more than one memory or different kinds of storage devices.

The prediction system 170 is configured to provide, in response to receiving a character input, one or more completion candidates for the input in one example. A completion candidate may in some examples be an ending for character input to form together with the character input a word or a part of a word. A completion candidate may be a language dependent logical unit that complies with grammatical rules of a language, and a suggestion of a likely continuation of a character input. In some examples the completion candidates may be based on a statistical language model by which a probability is assigned to any possible string of characters in a language and the string with the highest probability is offered or suggested as a completion candidate. It may also be possible to provide more than one completion candidate.

In an exemplary embodiment a statistical language model is used for determining a probability for a word. The determination may be done based on user behaviour by detecting the most often used words or phrases within a given context. In one embodiment, a probability for a word is determined by monitoring user input and analyzing possible endings for a word in terms of allowed character combinations in a given language. In another embodiment a probability for a word may be determined by determining the type of a previous word and estimating the most appropriate word. In a yet further embodiment a probability for a word may be determined by utilizing an in-built dictionary in an apparatus. In another embodiment the statistical language model is used for determining a probability for a character. The determination may be done based on grammatical or linguistic rules of a language. In another embodiment, a probability for a character is determined based on user behaviour in the past in terms of input characters by the user. In yet another embodiment, the statistical language model is used for determining a probability for a phrase. The determination may be done by any of the rules or any combination of the rules described above.

In general, a probability for a word, a character or a phrase may be determined in any of a number of ways, such as by using grammatical or linguistic rules, by monitoring user behaviour in terms of most often input text and/or characters or the latest input text and/or characters, by monitoring and analyzing user behaviour in the past, by analyzing one or more previous text inputs or any combination thereof.

The user interface 150 comprises an input device for inputting characters or more than one character at a time. As an example, a means for inputting characters may be a manually operable control such as button, a key, a touch screen, a touch pad, a joystick, a stylus, a pen, a roller, a rocker or similar. Further examples are a microphone, a speech recognition system, eye movement recognition system, acceleration, tilt and/or movement based input system.

The apparatus 100 may also include an output device. According to one embodiment illustrated in FIG. 1, the output device is a display 140 for presenting visual information for a user. The display 140 is configured to receive control signals provided by the processor 110. The display may be configured to present a character input and/or it may further be configured to visually present a completion candidate for the character input offered or suggested by the prediction system 170. However, it is also possible that the apparatus does not include a display or the display is an external display, separate from the apparatus itself.

In an alternative embodiment the apparatus 100 includes an output device such as a loudspeaker for presenting audio information for a user. The loudspeaker may be configured to receive control signals provided by the processor 110. The loudspeaker may be configured to present a character input and/or it may further be configured to audibly present a completion candidate for the character input offered or suggested by the prediction system 170. However, it is also possible that the apparatus does not include a loudspeaker or the loudspeaker is an external loudspeaker, separate from the apparatus itself.

In a further embodiment the apparatus 100 includes an output device such as a tactile feedback system for presenting tactile and/or haptic information for a user. The tactile feedback system may be configured to receive control signals provided by the processor 110. The tactile feedback system may be configured to present a character input and/or it may further be configured to present a completion candidate for the character input offered or suggested by the prediction system 170 by means of haptic feedback. For example, in one embodiment a tactile feedback system may cause the apparatus to vibrate in a certain way to inform a user of an input text and/or a completion candidate.

In yet a further embodiment the apparatus includes an output device that is any combination of a display, a loudspeaker and tactile feedback system. For example, a display may be used for presenting a character input and a loudspeaker and/or a tactile feedback system may be used for presenting an offered completion candidate.

Other embodiments may have additional and/or different components.

The apparatus may be an electronic device such as a hand-portable device, a mobile phone or a personal digital assistant (PDA), a personal computer (PC), a laptop, a desktop, a wireless terminal, a communication terminal, a game console, a music player, a CD- or DVD-player or a media player.

Computer program instructions for enabling implementation of example embodiments of the invention, or a part of such computer program instructions, may be downloaded from a data storage unit to the apparatus 100, by the manufacturer of the electronic device, by a user of the electronic device, or by the electronic device itself based on a download program, or the instructions can be pushed to the electronic device by an external device. The computer program instructions may arrive at the electronic device via an electromagnetic carrier signal or be copied from a physical entity such as a computer program product, a memory device or a record medium such as a CD-ROM or DVD.

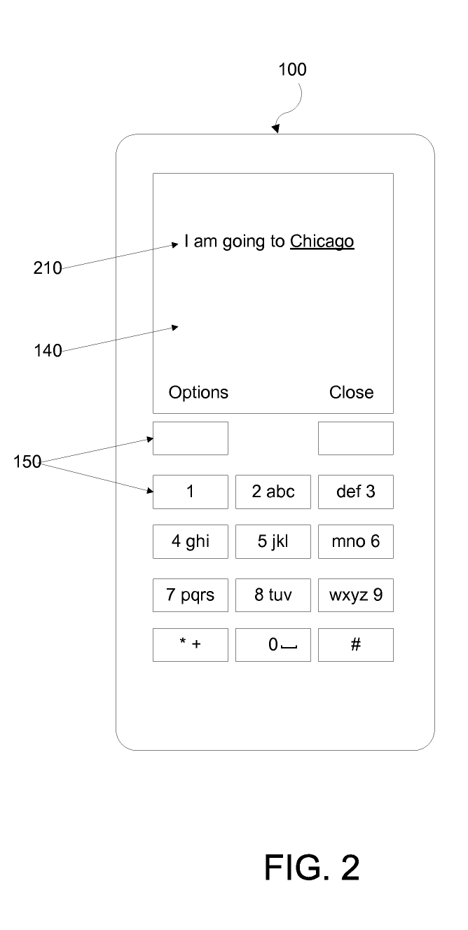

FIG. 2 illustrates an exemplary user interface incorporating aspects of the disclosed embodiments. An apparatus 100 comprises a display 140 and one or more keys 150 for inputting data into the apparatus 100. In this embodiment keys 150 may comprise alphanumeric keys for inputting characters and programmable keys for performing different kinds of state dependent operations such copying, cutting, inserting symbols or selecting a writing language. An alphanumeric key may comprise several characters mapped onto it. Alternatively, an alphanumeric key may comprise a single character mapped onto it. In general, a prediction system 170 may be used for predicting a completion candidate for character input to make text entry quicker.

The keypad in FIG. 2 is a keypad with multiple letters mapped onto the same key. Another exemplary keypad may be a keypad with hard keys and/or buttons, a touch screen keypad, a virtual keypad, a keypad used by detecting eye movement or a wheel used for entering characters, or any combination thereof.

Referring back to the example of FIG. 2, a user has input “I am going to ”, and based on a statistical language model the prediction system 170 offers “Chicago” as a completion candidate 210. In one example, the completion candidate is suggested based on a user's past behaviour. The prediction system may suggest the completion candidate, because the user most often types “Chicago” after the word “to” or because the prediction system notices that the next word should be a place name. In one embodiment, the determination of an upcoming place name may be based on the previous word. In another embodiment, the determination of an upcoming place name may be based on any number of previous words or characters. As illustrated in FIG. 2 the offered completion candidate may be presented with underlining to indicate the word that will be input if the user decides to accept the offered completion candidate. The user may also ignore the completion candidate by continuing typing.

In the example of FIG. 2, the suggested or offered completion candidate is a word. However, a completion candidate may also be a character, a combination of two or more characters, a syllable, a prefix, a suffix, a clause, a sentence, a phrase, a linguistic unit, a grammatical unit, a portion of text or a part of a word, for example.

According to one embodiment, for some languages a completion candidate may comprise parts of words allowing a user to add suffixes step by step such as a Finnish word oma+koti+talo+ssa+ni+kin (the English translation is “also in my house”). According to another embodiment, for a language with many short words, the completion candidates may comprise entire phrases such as “in spite of”, “long time no see”, “how do you do”, for example. In one exemplary embodiment, the prediction system may be configured to monitor input text and determine that certain words often occur together in a specific order. In another exemplary embodiment the prediction system continuously monitors user input and updates a completion candidate database and/or rules for suggesting completion candidates. According to a further exemplary embodiment, an input language is detected by the apparatus or selected by a user and the extent and/or the complexity of offered completion candidates is determined based on the detected language.

According to some exemplary embodiments, a completion candidate may be indicated by underlining, highlighting, animation, by changing text style or any other way suitable for making a user aware of a suggested completion candidate.

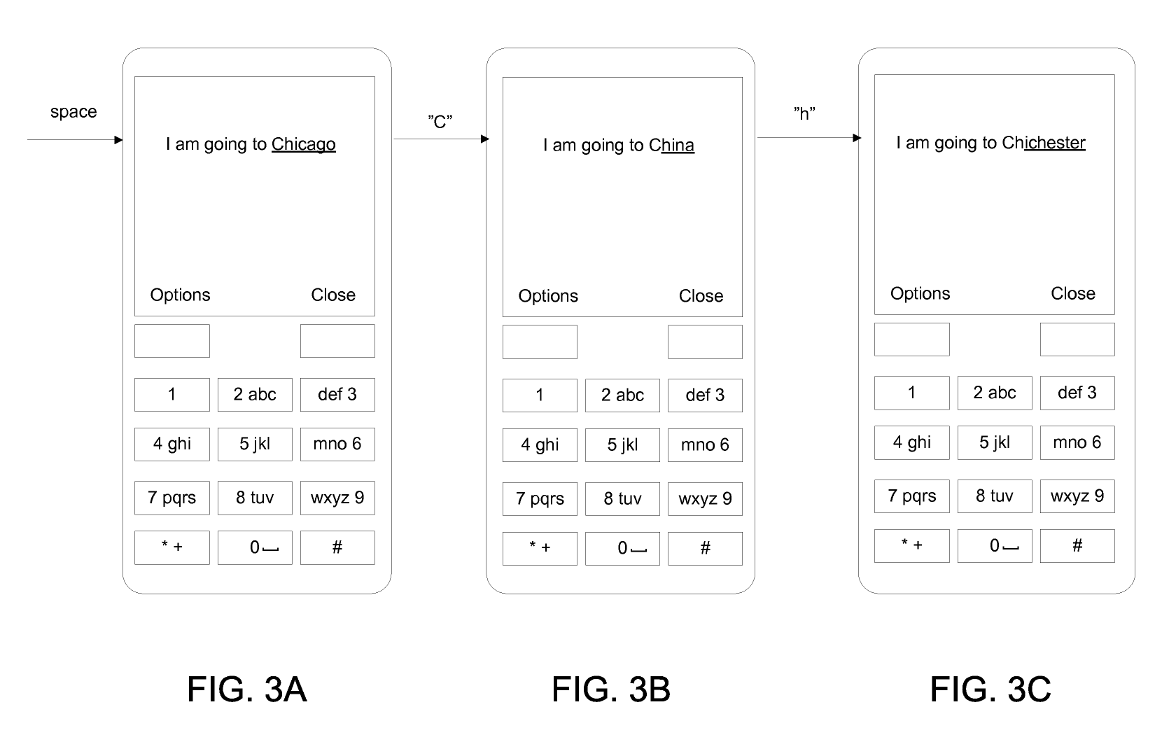

FIGS. 3A to 3C illustrate an exemplary method incorporating aspects of the disclosed embodiments. The user intends to type “I am going to Chichester”. After typing “I am going to ”, the statistical language model starts suggesting completion candidates for the next word. In this example, the completion candidate is a new, complete word, because the previous word is finished and no further inputs are received yet. The prediction system 170 may use a space as an indication that a word is finished. In this exemplary embodiment, it is assumed that the most probable candidates are Chicago, Boston, New York, China and Chichester, respectively. In this example, the most probable candidates are suggested based on previous usage. Since “Chicago” is the most probable candidate, it is the default for the first completion candidate and offered for the user in response to detecting a first user input, in this example a space, after the last word “to” as shown in FIG. 3A. In response to receiving a second user input, in this example the letter “C” by pressing the “2 abc” key, the prediction system 170 compares the received letter with the group of most probable candidates. Since neither Boston nor New York begins with “C” they are not considered as statistically the most probable candidates by the prediction system 170 any more. In this example, “Chicago” is still the best completion candidate, because it is statistically the most probable completion candidate that begins with “C”. However, since it has already been offered for the user, the prediction system system 170 interprets the user's action of inputting a further character, even though it still matches with the suggested completion candidate, as an instruction to discard the offered completion candidate. In other words, the user's action of inputting a further character indicates that the suggested completion candidate is not the one the user wishes to input, but the user wishes to input some other word. Therefore, the system chooses the next most probable completion candidate i.e. “China” and offers “hina” as a completion candidate as shown underlined in FIG. 3B.

In response to receiving a third input, in this example the letter “h” and the letter sequence now being “Ch”, the sequence still matches “Chicago” and “China”. However, since these candidates have already been offered as completion candidates, the third most probable candidate that has not been suggested so far is “Chichester”. Therefore, “ichester” is offered as a completion candidate as shown underlined in FIG. 3C. In response to detecting an instruction to accept the completion candidate, the word “Chichester” is inputted and the whole user input is now “I am going to Chichester”.

The example of FIGS. 3A to 3C discloses rotating completion candidates that are the most probable based on previous usage to complete a user input. In one exemplary embodiment rotating completion candidates comprises de-prioritizing a suggested completion candidate in response to receiving a further input that still matches with the suggested completion candidate. In other words, the completion system 170 is configured to rotate completion candidates in response to detecting that a further input by a user does not require changing the suggested candidate in terms of the further input still matching with the suggested completion candidate. In one exemplary embodiment de-prioritizing a suggested completion candidate comprises moving the suggested completion candidate to the last position among completion candidates matching with a user input. In another exemplary embodiment de-prioritizing a suggested completion candidate comprises moving the suggested completion candidate to a lower position among completion candidates matching with a user input. In a further exemplary embodiment de-prioritizing a suggested completion candidate comprises prioritizing one or more other completion candidates over the suggested completion candidate. According to one exemplary embodiment a list comprising completion candidates matching with a user input is provided by the prediction system 170 and the prediction system 170 is configured to de-prioritize a suggested completion candidate by moving the suggested completion candidate to a lower position on the list. According to another exemplary embodiment de-prioritizing a suggested completion candidate comprises moving the suggested completion candidate to a separate list comprising suggested completion candidates.

In one exemplary embodiment, the completion candidates are rotated in terms of providing a new completion candidate after each input. In another exemplary embodiment the completion candidates are rotated i.e. the next completion candidate is provided after receiving two inputs. In a further exemplary embodiment the completion candidates are rotated after receiving three inputs. In a yet further exemplary embodiment the completion candidates are rotated after receiving four or more inputs.

According to one exemplary embodiment, the number of inputs used as a trigger to rotate the completion candidates is updated dynamically based on a user's behaviour. For example, if the user eventually inputs a user input that was actually previously offered, the number of inputs used as a trigger to rotate the completion candidates may be increased. Inputting a user input that was suggested previously indicates that a user has not observed the display or at least has not reacted to it. Therefore, increasing the number of inputs used as a trigger to rotate the completion candidates i.e. decreasing the frequency of rotation, aims at optimizing the frequency for the user's skills and needs. In one exemplary embodiment the number of inputs used as a trigger to rotate the completion candidates is determined by a user. On the other hand, if the user rarely inputs a user input that was previously offered as a completion candidate, the number of inputs used as a trigger to rotate the completion candidates may be decreased. The fact that the user very rarely inputs a user input that was previously suggested, indicates that the user is familiar with the rotating of completion candidates and a higher frequency of rotating the completion candidates might be possible.

According to one exemplary embodiment, a user input may be a character, a combination of two or more characters, a syllable, a prefix, a suffix, a clause, a sentence, a phrase, a linguistic unit, a grammatical unit, a word or a part of a word, for example. Referring back to FIGS. 3B and 3C, the letter “C” input by a user and shown in FIG. 3B may be regarded as a user input. In addition, the letter combination of “Ch” input by a user and shown in FIG. 3C may also be regarded as a user input. In fact, a user input may be any character combination the user has input so far and each user input evolves as long as further user inputs are received and the user input is not completed by a separator, for example.

In the example of FIGS. 3A to 3C, only one completion candidate is presented to the user. However, it may be possible to present more than one completion candidate to the user. According to one exemplary embodiment, a list comprising more than one completion candidate matching with a user input may be presented. According to another exemplary embodiment the prediction system 170 is configured to provide a list comprising more than one completion candidate to be presented to the user in a pop-up window. According to a further exemplary embodiment the prediction system 170 is configured to provide a list comprising more than one completion candidate to be presented to the user in a dedicated field on the display 140. Referring back to the example of FIG. 3C, the user input is the letter combination “Ch” which matches with Chicago, China and Chichester all of which may be presented to the user in a pop-up window or in a dedicated field, for example. In one exemplary embodiment all the possible completion candidates for a user input are presented to the user. In another exemplary embodiment a pre-determined number of possible completion candidates are presented to the user. In a further exemplary embodiment a pre-determined number of possible candidates that are statistically most probable to complete a user input are presented to the user.

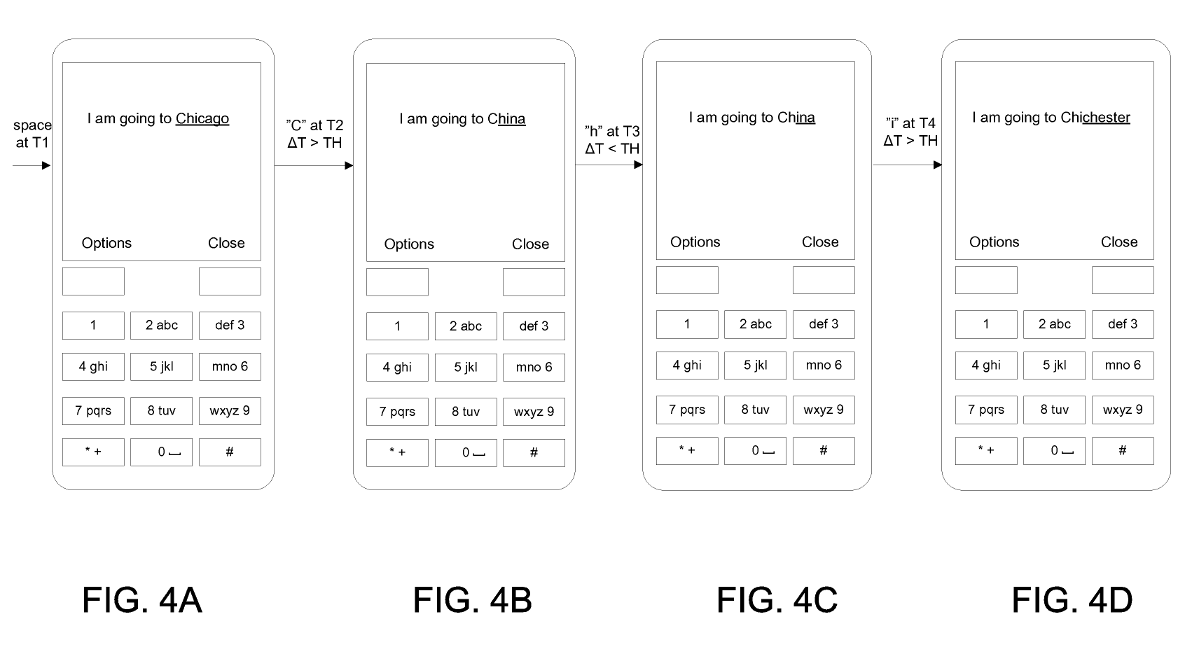

FIGS. 4A to 4D illustrate another exemplary method incorporating aspects of the disclosed embodiments. As is the previous example, the user intends to type “I am going to Chichester”. After typing “I am going to ”, the language model starts suggesting completion candidates for the following word. According to one exemplary embodiment, the prediction system 170 offers a new word if a separator such as a space, a comma or a colon is detected. According to another exemplary embodiment, the prediction system 170 offers a new word if the previous word has been accepted by a user. In an exemplary embodiment, it is assumed that the most probable words based on previous user inputs are Chicago, Boston, New York, China and Chichester, respectively.

In this embodiment, a completion candidate is suggested based on a previously suggested completion candidate and a time difference between two inputs. By using the time difference as an additional criterion to rotate completion candidates, possible misinterpretations of a user's actions may be reduced in terms of interpreting whether the user has observed and/or reacted to the suggested completion candidates. In one exemplary embodiment, a small time difference i.e. a time difference that is less than a threshold value may be considered as an indication that the user has not observed or at least not reacted to a suggested completion candidate. Therefore, if the completion candidates were rotated, the user might miss a candidate that actually is the one he needs. In another exemplary embodiment, a time difference greater than a threshold value may be considered as an indication that the user has observed or reacted to a suggested completion candidate. Therefore, rotating the completion candidates may be done based on an assumption that the suggested candidate is not the one the user needs and further inputs by the user are deliberate, even though the further inputs still match with the suggested candidate. Therefore, the next completion candidate is suggested for the user.

Referring back to the example of FIG. 4A, “Chicago” is suggested by the prediction system 170 as a completion candidate based on previous user inputs. In this example a completion candidate is a new word, because no inputs have been received after completing the previous word “to”. The underlining in FIG. 4A visually indicates the suggested completion candidate for the user. The most probable candidate “Chicago” is suggested in response to detecting a first input at a first point in time T1, in this example the first input being a space after the last word “to”. According to this example, the first point in time T1 is saved for later use. In response to receiving a second user input at a second point in time T2, in this example the letter “C” by pressing the “2 abc” key, “Chicago” is still the best completion candidate, because it is the most probable completion candidate that starts with a letter “C”. The time difference ΔT between the first input at T1 and the second input at T2 is determined and compared to a threshold value TH. If the time difference between the first point in time and the second point in time is greater than the threshold value TH, it is assumed that the user noticed the completion candidate suggested by the prediction system 170, and that since he still decided to input the letter “C”, “Chicago” may not be the word the user wants and a new completion candidate is suggested by the prediction system 170. On the other hand, if the time difference between the first point in time and the second point in time is less than the threshold value TH, it is assumed that the user has not observed the display or at least he has not reacted to it.

In FIG. 4B, since the user after a deliberation, in terms of the time difference ΔT being greater than a threshold value, decided to input the letter “C” it was assumed that “Chicago” is not the word he wanted, the next most probable word is “China”, because based on previous user inputs it is the most probable candidate that starts with the letter “C”. As illustrated by underlining in the example of FIG. 4B, a completion candidate “hina” is offered to the user.

Next, the user inputs a further input at a third point in time T3, in this example the letter “h” and the letter sequence now is “Ch”, still matching with “China”. The time difference ΔT between the third point in time T3 and the second point in time T2 is determined and compared to the threshold value TH. In this example, the time difference is less than the threshold value TH and therefore it is assumed that the user did not observe the display or at least did not react to the suggested completion candidate “hina”. Therefore, completion candidates are not rotated by the prediction system 170, but “China” is still regarded as the most probable user input. The suggested completion candidate “ina” is offered to the user as illustrated by underlining in the example of FIG. 4C.

Referring to FIG. 4D, the user inputs still a further input at a fourth point in time Tfo, in this example the letter “i” and the letter sequence now is “Chi”, still matching with “Chicago” and “China”. The time difference ΔT between the fourth point in time T3T4 and the third point in time T2T3 is determined and compared to the threshold value TH. If the time difference is greater than the threshold value TH, it is assumed that the user deliberately input a matching character and in this way wishes to indicate that “China” is not the word he wants. Therefore, the completion candidates are rotated by the prediction system 170 and the third most probable candidate “Chichester” is suggested to the user. The completion candidate “chester” is illustrated by underlining to the user as shown in FIG. 4D.

In response to detecting an instruction to accept the completion candidate, the input characters “Chi” and the completion candidate “chester” are combined to form the word “Chichester” and the whole user input is now “I am going to Chichester”. In one exemplary embodiment, the user accepts a completion candidate by selecting a specified key. In another exemplary embodiment, a completion candidate is automatically accepted after a pre-determined time delay.

In one exemplary embodiment, the threshold value for the time difference between two inputs used as a trigger to rotate the completion candidates is updated dynamically based on a user's behaviour. For example, if the user eventually inputs a user input that was actually previously suggested, the threshold value may be increased. In another exemplary embodiment, the threshold value used as a trigger to rotate the completion candidates may be determined by a user.

As explained in the examples above, a time difference between a first input and a second input may be used as a trigger for rotating the completion candidates when a user input still matches with a candidate suggested by the prediction system 170. A time difference that is greater than a threshold value may be interpreted as an instruction to rotate the completion candidates. According to one exemplary embodiment, the user is able to control the rotating of completion candidates by input speed. With a high input speed, the time difference between two inputs being less than a threshold value, the user can instruct the prediction system 170 not to rotate the completion candidates, because he is not observing the suggested completion candidates. With a low input speed, the time difference between two inputs being greater than a threshold value, the user can instruct the prediction system 170 to rotate the completion candidates.

In one exemplary embodiment rotating completion candidates comprises de-prioritizing a suggested completion candidate based on a further input by a user and a time difference between the further input and a previous input. According to one exemplary embodiment the prediction system 170 is configured to de-prioritize a suggested completion candidate in response to receiving a further input still matching with the suggested completion candidate if the time difference between the further input and a previous input is greater than a threshold value. In other words, the completion system 170 is configured to rotate completion candidates in response to detecting that a further input by a user does not require changing the suggested candidate in terms of the further input still matching with the suggested completion candidate and to detecting that a time difference with a further input and a previous input is less than a threshold value. Even though the example of FIGS. 4A to 4D only presents one completion candidate to a user at a time, more than one completion candidate may be presented simultaneously. According to one exemplary embodiment the prediction system 170 is configured to provide a list of completion candidates presented to a user on the display 140 with a suggested candidate at a high position on the list and de-prioritizing the suggested candidate comprises moving the suggested candidate to a lower position on the list.

Referring back to the example of FIGS. 4A to 4D, where it is assumed that the most probable words based on previous user inputs are Chicago, Boston, New York, China and Chichester, respectively. In one example, a list comprising the most probable words may be presented to a user where the completion candidate with the highest probability i.e “Chicago” is at the top position and the completion candidate with the lowest probability i.e. “Chichester” is at the bottom position. In the example, of FIGS. 4A to 4D, in response to receiving the space character at the first point in time T1, the list of completion candidates to be rotated comprises Chicago, Boston, New York, China and Chichester, respectively and “Chicago” is suggested as the most probable completion candidate. In response to receiving the letter “C” at a second point in time T2 and the time difference between the second point in time T2 and the first point in time T1 being greater than a threshold value TH, the completion candidates are rotated by the prediction system 170 in terms of de-prioritazing “Chicago” by moving it to the lowest position on the list in this example. In addition, since “Boston” and “New York” no longer match with the user input, they are removed from the list by the prediction system 170. In other words, the list comprising completion candidates for a user input now includes China, Chichester and Chicago, respectively and “China” being at the top of the list is presented to the user. In response to receiving the letter “h” at a third point in time T3 and the time difference between the third point in time T3 and the second point in time T2 being less than a threshold value TH, it is assumed that the user has not observed the display or at least reacted to the suggested completion candidate. Therefore, the completion candidates are not rotated by the prediction system 170 and accordingly the list comprising completion candidates need not be updated. Accordingly, “China” is still suggested to the user. In response to receiving the letter “i” at a fourth point in time T4 and the time difference between the fourth point in time T4 and the third point in time T3 being greater greater than a threshold value TH, the completion candidates are rotated by the prediction system 170 in terms of de-prioritazing “China” by moving it to the lowest position on the list and moving the other completion candidates to a higher position. According to this example the list comprising completion candidates for a user input now includes Chichester, Chicago and China respectively and “Chichester” being now at the top of the list is suggested to the user.

According to one exemplary embodiment, the trigger for rotating candidates is a combination of a number of received user inputs and a threshold value for a time difference between two inputs. According to another exemplary embodiment, both the number of received user inputs and the threshold value used as a trigger to rotate the completion candidates are updated dynamically based on a user's behaviour. In one exemplary embodiment, if the user eventually inputs a user input that was actually previously offered as a completion candidate, the number of inputs and the threshold value used as a trigger to rotate the completion candidates may be increased. In another exemplary embodiment, the number of inputs and/or the time difference used as a trigger to rotate the completion candidates are determined by a user.

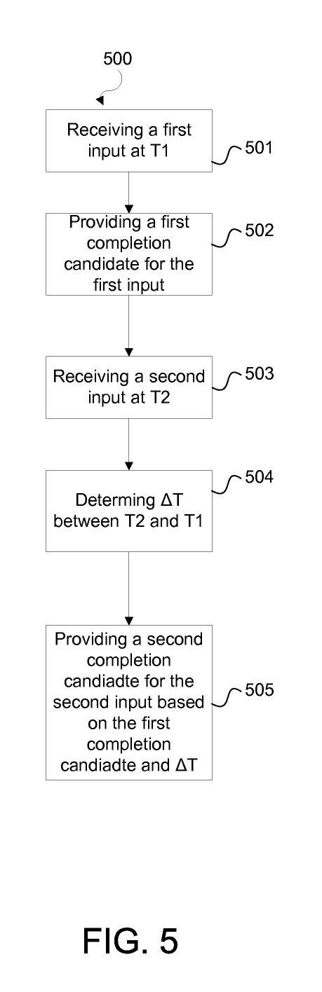

FIG. 5 illustrates an exemplary process 500 incorporating aspects of the disclosed embodiments. In a first aspect a first user input is received 501 at a first point in time T1. According to an exemplary embodiment the first user input comprises text input. In response to receiving the first user input, a first completion candidate is provided 502 for the first user input by the prediction system 170. The completion candidate comprises one or more characters that together with the first user input form a logical information carrying unit for the user such as a word, an abbreviation, a syllable or a phrase, for example. A second user input is received 503 at a second point in time T2. According to an exemplary embodiment the second user input comprises text input. According to this exemplary embodiment, a time difference ΔT between the second point in time T2 and the first point in time T1 is determined 504 and a second completion candidate for the second user input is provided 505 based on the first completion candidate and the time difference ΔT.

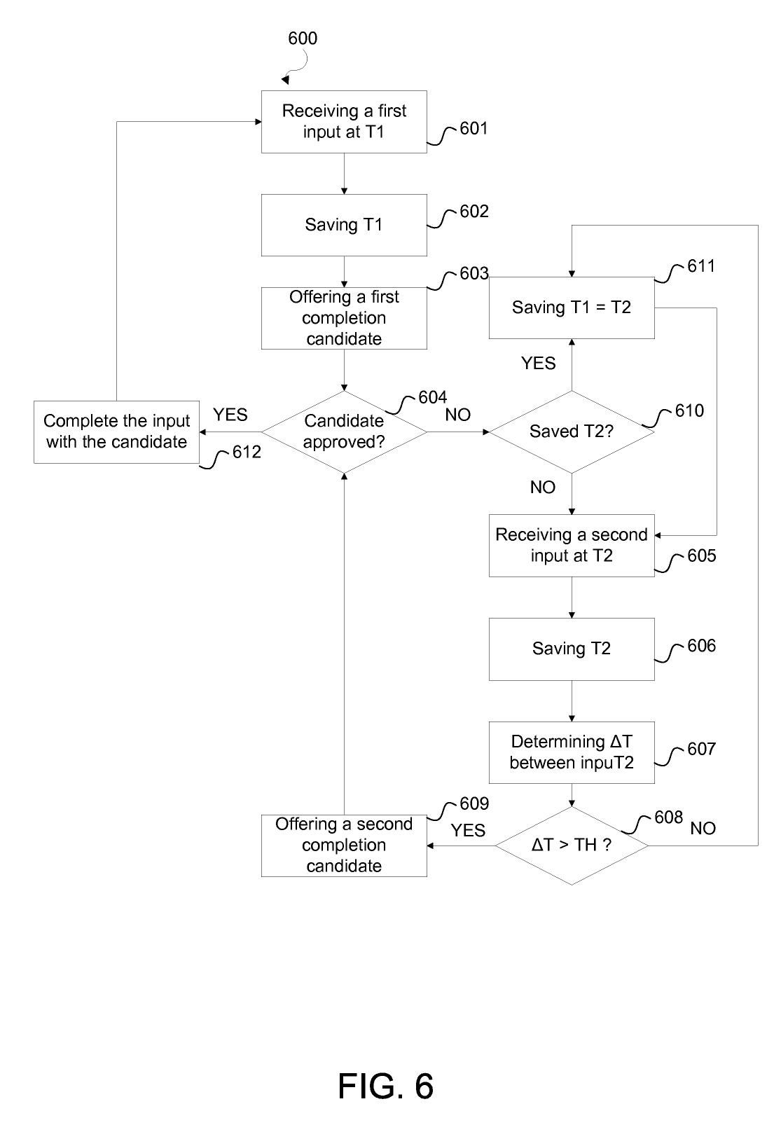

FIG. 6 illustrates another exemplary process 600 incorporating aspects of the disclosed embodiments. In a first aspect, a first user input is received 601 at a first point in time T1. The first point in time may be saved or stored 602 for later use. In response to receiving a first user input, a first completion candidate is suggested 603 by the prediction system 170 to complete the first user input in terms of providing a possible character combination that together with the first user input forms a logical information carrying unit for the user. The user may select the suggested first completion candidate to complete the first user input 612 or ignore the first completion candidate by inputting a second user input.

In this example, if the suggested completion candidate was not approved 604 by the user inputting a further input, a second user input is received 605 at a second point in time T2. The second point in time may be saved or stored 606 for later use. In response to receiving the second user input, the time period ΔT between the first user input and the second user input is determined 607. The determination may be based on determining the time difference between the second point in time T2 and the first point in time T1. If the time difference is big i.e. greater than a threshold value TH 608 and the second user input still matches with the offered first completion candidate, it is assumed that the offered first completion candidate is not the one the user wants. Therefore, a second completion candidate is offered 609 by the prediction system 170. The user may select the offered first completion candidate to complete the first input or ignore the first completion candidate by inputting a third input.

According to the example process of FIG. 6, a third input may be received at a third point in time T3. The third point in time T3 may be saved or stored for later use. According to one exemplary embodiment, if there already is a stored second point in time T2 610, the stored first point in time T1 is replaced with the stored value of second point in time T2 611 and the third point in time T3 is stored as a second point in time T2, and the time difference is determined between the replaced second point T2′ in time and the replaced first point in time T1′. According to this exemplary embodiment, it may be possible to minimize the number of stored time points. According to another exemplary embodiment, the previously stored points in time are kept and an additional point in time is also stored.

The determined time difference is small when it is less than a threshold value. The determined time difference is big when it is greater than a threshold value. According to one exemplary embodiment, the threshold value may be a pre-determined threshold value or a dynamic threshold value that is updated according to a user's behaviour. For example, an optimal value for a time-out between the first user input and the second user input may be learned on-line, for example during use of prediction process by the user, by detecting the complete input by the user. If the user inputs a user input was suggested to him previously, but which he discarded by inputting further inputs, the threshold value may be increased. In another exemplary embodiment, if the user most often inputs a user input that was not suggested to him, the threshold value may be decreased.

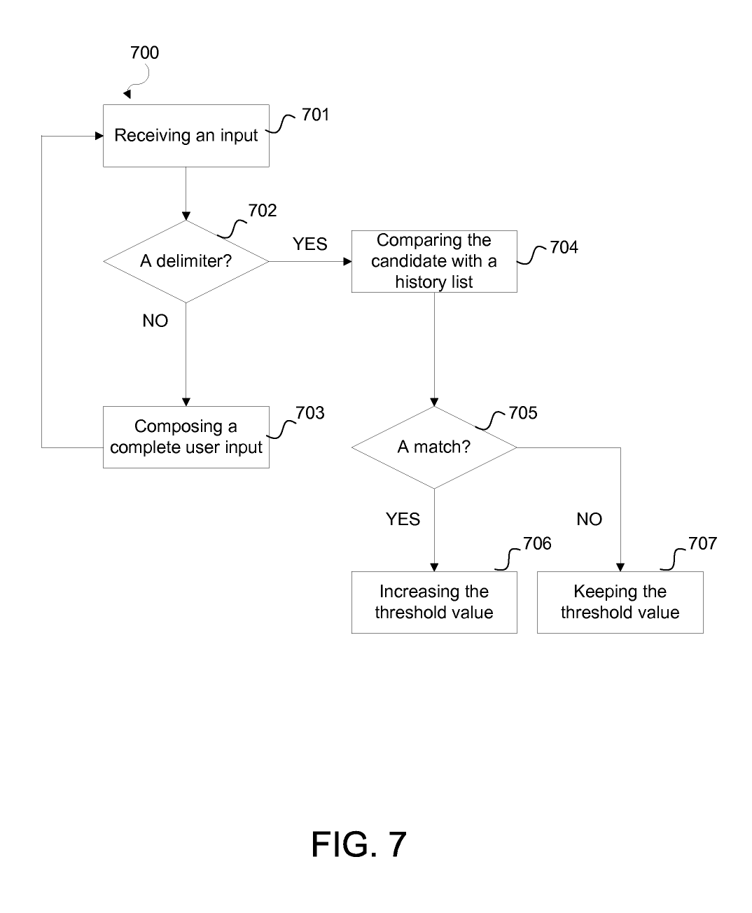

FIG. 7 illustrates another exemplary process 700 incorporating aspects of the disclosed embodiments. In a first aspect, a user input is received at step 701. In the example of FIG. 7, if the input is not a delimiter 702, further inputs are received and added to the composed user input until a delimiter is received 702. According to one exemplary embodiment, a delimiter may be a word delimiter such as a space, a tabulator, a comma, a period, a semi-colon or any other delimiter. The received inputs between any two delimiters are considered as a complete user input. According to one exemplary embodiment, the complete user input is compared with a history list comprising suggested completion candidates 704 to find out whether any suggested completion candidate matches with the complete user input 705. According to one exemplary embodiment the history list may include all previously suggested completion candidates for an input. According to another exemplary embodiment the history list may include all previously suggested completion candidates during a text input session such as when writing a message. According to a further exemplary embodiment the history list may include all previously suggested completion candidates for a combination of words. In the example of FIG. 7, if there is a match, the threshold value TH for rotating candidates is increased. In this way, the rotating of candidates may be adjusted according to a user's skills. If the complete user input matches with any candidate on the history list comprising suggested candidates, it may be assumed that the user has not noticed or at least reacted to a suggested candidate and there may be a need to slow down the rotation of candidates. According to the example of FIG. 7, the possibility of inadvertently missing offered candidates is reduced. If there is no match, the threshold value TH may be kept the same 707. Alternatively, the threshold value TH may even be decreased if the user rarely misses any offered candidates.

A history list may be stored on the memory 160 or any other suitable computer readable medium. Any suggested completion candidate may be included in the history list until the list is cleared. According to one exemplary embodiment the history list comprising suggested completion candidates is cleared in response to receiving an editing command. For example, if the user hits backspace or chooses some other user input editing or user input deletion operation using the user interface 150 of the apparatus 100, the history list of offered completion candidates may be cleared and the rotation of completion candidates may start from the beginning with the most probable completion candidate.

In general, the faster the user is typing, the more likely it is that the user has not reacted to an offered completion candidate. The text input speed can be used as a trigger to rotate completion candidates. According to one exemplary embodiment, rotating completion candidates comprises suggesting at least one completion candidate in response to receiving an input. According to another exemplary embodiment, rotating completion candidates may also comprise removing a previously suggested completion candidate and/or replacing a previously suggested completion candidate with a new completion candidate. According to a further exemplary embodiment, rotating input candidates may also include suggesting a previously suggested completion candidate as a completion candidate. According to a yet further embodiment, rotating completion candidates may also comprise including a suggested completion candidate in a history list comprising suggested completion candidates.

According to one exemplary embodiment, the rotation of candidates is done at certain time intervals without user input. For example, the user may input characters and then wait for the apparatus to suggest completion candidates for the received input. The completion candidates may be presented one by one or more than one candidate at once. The user may then select the most appropriate completion candidate to complete the user input.

Without in any way limiting the scope, interpretation, or application of the claims appearing below, a technical effect of one or more of the example embodiments disclosed herein is that by rotating completion candidates less key presses may be needed to input text and therefore faster text entry may be possible. For example, for devices with keypads where multiple characters are mapped to each key, text entry may be less burdensome when a number of needed keypresses is decreased. For example, compared to a known system where the completion candidate is only changed when the most probable word does not match the input sequence anymore, the example embodiments may save the user several key presses. With regard to the “Chichester” example and using the apparatus of FIG. 1, three key presses may be saved, since with a known system “Chichester” would only have been offered after inputting “Chich”. Another technical effect of one or more of the example embodiments disclosed herein is that the user may have a better understanding of the most probable completion candidates. For example, in a known system, “Chicago” is suggested as long and the user has input “Chich” and then “Chichester” is offered. However, because of rotating the completion candidates the word “China” is offered for the user in response to detecting that the user is not interested in the word “Chicago”. Another technical effect of one or more of the example embodiments disclosed herein is that a text input system may be better adapated to a user's skills when a trigger for rotating completion candidates is dynamically updated based on a user's behaviour. Another technical effect of one or more of the example embodiments disclosed herein is that text inputting may be optimized in terms of reliability by combining different kinds of triggers for rotating completion candidates such as using the combination of a delay between key presses and a number of key presses for rotating completion candidates.

Embodiments of the present invention may be implemented in software, hardware, application logic or a combination of software, hardware and application logic. The software, application logic and/or hardware may reside on the apparatus, a separate device or a pluraility of devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving a first text input at a first point in time;
providing a first completion candidate for the first text input;
receiving a second text input at a second point in time;
determining a time difference between the second point in time and the first point in time; and
providing a second completion candidate for the second text input based on at least the first completion candidate and the time difference.

2. The method of claim 1, wherein a first portion of the first completion candidate matches with the first text input and a second portion of the first completion candidate matches with the second text input.

3. The method of claim 1, wherein the second completion candidate is provided if the time difference between the second point in time and the first point in time is greater than a threshold value.

4. The method of claim 3, further comprising receiving one or more further text inputs and combining the first text input, the second text input and the one or more further text inputs into a text input composition.

5. The method of claim 4, further comprising varying the threshold value based on the text input composition and a previously provided completion candidate.

6. The method of claim 5, further comprising increasing the threshold value if the text input composition matches with a previously provided completion candidate.

7. The method of claim 4, wherein the text input composition comprises a word.

8. The method of claim 4, wherein the text input composition comprises a phrase.

9. The method of claim 1, further comprising adding the first completion candidate to a history list comprising provided completion candidates.

10. The method of claim 9, further comprising clearing the history list in response to an edit command.

11. An apparatus, comprising:
a processor,
memory including computer program code, the memory and the computer program code configured to, working with the processor, cause the apparatus to perform at least the following:
receive a first text input at a first point in time;
provide a first completion candidate for the first text input in response to receiving the first text input;
receive a second text input at a second point in time;
determine a time difference between the second point in time and the first point in time in response to receiving the second text input; and
provide a second completion candidate for the second text input based on the first input candidate and the time difference.

12. The apparatus of claim 11, wherein a first portion of the first completion candidate matches with the first text input and a second portion of the first completion candidate matches with the second text input.

13. The apparatus of claim 11, wherein the processor is configured to provide the second completion candidate if the time difference between the second point in time and the first point in time is greater than a threshold value.

14. The apparatus of claim 13, wherein the processor if further configured to receive one or more further text inputs and to combine the first text input, the second text input and the one or more further text inputs into a text input composition.

15. The apparatus of claim 14, wherein the processor is further configured to vary the threshold value based on the text input composition and a previously provided completion candidate.

16. The apparatus of claim 15, wherein the processor is configured to increase the threshold value if the text input composition matches with a previously provided completion candidate.

17. The apparatus of claim 14, wherein the text input composition comprises a word.

18. The apparatus of claim 14, wherein the text input composition comprises a phrase.

19. The apparatus of claim 11, wherein the processor is further configured to add the first completion candidate to a history list comprising provided completion candidates.

20. The apparatus of claim 19, wherein the processor is configured to clear the history list in response to an edit command.

21. A computer program product comprising a computer-readable medium bearing computer program code embodied therein for use with a computer, the computer program code comprising:
code for receiving a first text input at a first point in time;
code for providing a first completion candidate for the first text input;
code for receiving a second text input at a second point in time;
code for determining a time difference between the second point in time and the first point in time; and
code for providing a second completion candidate for the second text input based on the first input candidate and the time difference.

22. The computer program product of claim 21, wherein a first portion of the first completion candidate matches with the first input and a second portion of the first completion candidate matches with the second input.

23. The computer program product of claim 21, comprising code for providing the second completion candidate if the time difference between the second point in time and the first point in time is greater than a threshold value.

24. The computer program product of claim 21, further comprising code for receiving one or more further text inputs and for combining the first text input, the second text input and the one or more further text inputs into a text input composition.

25. The computer program product of claims 23 and 24, further comprising code for varying the threshold value based on the text input composition and a previously provided completion candidate.

26. The computer program product of claim 25, further comprising code for increasing the threshold value if the text input composition matches with a previously provided completion candidate.

27. The computer program product of claim 21, further comprising code for adding the first completion candidate to a history list comprising provided completion candidates.

28. The computer program product of claim 27, further comprising code for clearing the history list in response to an edit command.

29. An apparatus comprising:
means for receiving a first text input at a first point in time;
means for providing a first completion candidate for the first text input;
means for receiving a second text input at a second point in time;
means for determining a time difference between the second point in time and the first point in time; and
means for providing a second completion candidate for the second text input based on the first input candidate and the time difference.
